(19) United States
(12) Patent Application Publication
(10) Pub. No.: US 2026/0148190 A1
(43) Pub. Date: May 28, 2026

(54) SYSTEM AND METHOD FOR TESTING INFORMATION ABOUT A USER

(71) Applicant: The PNC Financial Services Group, Inc., Pittsburgh, PA (US)

(72) Inventors: Jung WINGER, Pittsburgh, PA (US); Isabel ZEHNER, Pittsburgh, PA (US); Fred GULIZIA, Pittsburgh, PA (US); Jennifer TULLIO, Pittsburgh, PA (US)

(73) Assignee: The PNC Financial Services Group, Inc., Pittsburgh, PA (US)

(21) Appl. No.: 19/333,921

(22) Filed: Sep. 19, 2025

Related U.S. Application Data
(60) Provisional application No. 63/724,605, filed on Nov. 25, 2024.

(51) Int. Cl. G06Q 10/105; G06F 9/451; G06F 16/248

(52) U.S. Cl. CPC G06Q 10/105; G06F 9/451; G06F 16/248

(57) ABSTRACT

Systems and methods for testing user information are provided. The system may include a memory and processor, wherein the memory stores instructions for the processor to execute, including: receiving information about a user, the information about the user including a user identifier (ID); receiving a testing request including a test rule, information about a database, and a data source in the database. The processor may be configured to retrieve the data source including a plurality of employee identifiers (IDs) from the database, combine the information about the user and the data source using a data join scheme to obtain a joint user data, the joint user data including one of the plurality of employee IDs corresponding to the user, search the user ID in the joint user data to obtain a search result, and generate a test result based on the search result and the test rule.

### CROSS REFERENCES TO RELATED APPLICATIONS

This application claims the benefit of priority of U.S. Provisional Patent Application No. 63/724,605, filed Nov. 25, 2024, the contents of which are incorporated herein by reference in its entirety.

### TECHNICAL FIELD

The present disclosure relates to systems and methods for testing information about a user, more specifically, to look up the information about the user among different data sources and showing a look up result on a dashboard of a visualization application.

### BACKGROUND

In current enterprise environments, user identity data may be fragmented across multiple internal systems, such as human resource (HR) management system, identity management system, applicant accounts, and service accounts, etc. This fragmentation may result in user IDs being distributed across the different systems, making it labor-intensive and inefficient for auditors or other stakeholders to retrieve comprehensive user information. Typically, stakeholders must query each system individually to gather relevant data.

A key challenge may also arise when only a user ID is available-retrieving associated employee details such as name, business unit, reporting manager, hire date, and termination date becomes difficult. This information is critical for internal audit teams to evaluate the appropriateness of application access. However, since the data is dispersed across multiple systems, and is often decentralized, auditors must perform cross-system queries and consolidate information using expert labeled data, which is cumbersome and time-intensive, and may hinder efficient audit operations.

To address these challenges, there is a need for a tool that can quickly and efficiently query relevant tables across different systems and display user ID information, thereby streamlining access to consolidated employee data. The disclosed systems and methods may increase efficiency by automating cross-system queries, saving time and effort. In addition, centralized access to user data may reduce the risk of errors. The disclosed embodiments may also increase scalability, by making the systems and data sources adaptable to evolving system environments. Further, there may be increased security and compliance with internal policies and external regulations by streamlining access to identity data.

### SUMMARY

Embodiments of the present disclosure provide user information lookup systems and methods for combining multiple data sources in a database with a file that includes user information under tested. The user information lookup systems and methods may be implemented through a visualization application. Instead of having to look up user identifier (ID) across multiple data sources, the visualization application may be performed to combine the file and the data sources. The user information can be tested easily by inputting the user ID into the file, and the test result may be updated corresponding to the user ID, thereby saving hours of manual research and improving data access efficiency.

Embodiments of the present disclosure may include a system for testing user information. The system may include a memory configured to store instructions and a processor communicatively connected to the memory and configured to execute the instructions to receive information about a user. The information about the user may include a user ID. The processor may receive a testing request. The testing request may include a test rule, information about a database, and a data source in the database. The processor may also retrieve the data source from the database. The data source may include a plurality of employee identifiers (IDs). The processor may also be configured to combine the information about the user and the data source using a data join scheme to obtain a joint user data. The joint user data may include one of the plurality of employee IDs corresponding to the user. The processor may also be configured to search the user ID in the joint user data to obtain a search result, and generate a test result based on the search result and the test rule.

In some embodiments, the processor may be configured to display the test result on a dashboard, and refresh the dashboard automatically in response to an update of the information about the user.

In some embodiments, when testing the information about the user, the processor may be further configured to execute the instructions to perform a search query in the data source using the user ID, determine whether the user ID is found in the data sources, return a number of a missing user ID that is not found in the data source, and display the number of the missing user ID on the dashboard.

In some embodiments, the data source includes a human capital reporting (HCR) data source and an identity management data source.

In some embodiments, the test rule may include testing the user ID exists in at least one of the HCR data source and the identity management data source.

In some embodiments, the processor may be further configured to execute the instructions to perform a search query in the HCR data source and the identity management data source using the user ID, determine whether the user ID is found in at least one of the HCR data source and the identity management data source, obtain a number of a found user ID, and display the number of the found user ID on the dashboard.

In some embodiments, the test rule may include testing a status information corresponding to the user ID in the HCR data source.

In some embodiments, the status information may include an active status and an inactive status. When testing the information about the user, the processor may be further configured to execute the instructions to perform a search query in the HCR data source using the user ID, obtain the status information corresponding to the user ID, obtain a number of the user ID with the status information, and display the number of the found user ID on the dashboard.

In some embodiments, the status information further includes a terminated status.

In some embodiments, the identity management database may include a service account (SA) file recording an access right of the user.

In some embodiments, the processor may be further configured to execute the instructions to perform a search query in the SA file using the user ID, determine whether the user ID is found in the SA file, upon determining the user ID is found in the SA file, obtain a number of the user ID that is found in the SA file, and display the number of the found user ID on the dashboard.

In some embodiments, the identity management data source may include an applicant data file recording an access right of the user.

In some embodiments, when testing the information about the user, the processor may be further configured to execute the instructions to perform a search query in the applicant data file using the user ID, determine whether the user ID is found in the applicant data file, upon determining the user ID is found in the applicant data file, obtain a number of the user ID that is found in the applicant data file, and display the number of the found user ID on the dashboard.

In some embodiments, the information about the user further includes a user email address.

In some embodiments, the processor may be further configured to execute the instructions to connect a workbook of a data visualization application to the information about the user, connect the workbook to the database, and establish a connection to the information about the user and the data source for the data join scheme.

In some embodiments, the processor may be further configured to execute the instructions to receive a user input to define the data join scheme between the information about the user and the data source based a common field between the information about the user and the data source.

In some embodiments, the data join scheme may be at least one of an inner join type, a left join type, a right join type, or a full outer join type.

In some embodiments, the test rule includes testing the data source to determine whether the user ID is absent.

Embodiments of the present disclosure may include a computer-implemented method for testing information about a user. The method may be performed by at least one processor. The method may include receiving a file including user information, the user information including a user email address, receiving a virtual table stored in a database, the virtual table including an employee identifier (ID), and the database including a plurality of data sources, connecting a workbook of a data visualization application to the file, connecting the workbook to the data source, establishing a connection to the file and the virtual table to perform a data join scheme, performing the data join scheme to join the file with the virtual table, receiving a testing request including a test rule and data source information corresponding to the data source, performing a user information lookup, using the user email address, by searching the data source corresponding to the data source information based on the test rule, and generating a dashboard to display a test result based on the user information lookup.

Embodiments of the present disclosure may include a computer-implemented method for testing information about a user. The method may be performed by at least one processor. The method may include connecting a workbook of a data visualization application to a file including user information, the user information including a user identifier (ID), connecting the workbook to the data source, the data source storing a plurality of virtual table, the virtual table including an employee identifier, and the database including a plurality of data sources, establishing a connection to the file and the virtual table, performing a data join scheme that joins the user list with the virtual table, receiving a testing request including a test rule and data source information corresponding to data source, performing a user information lookup, using the user ID, by searching the data source corresponding to the data source information based on the test rule, and generating a dashboard to display a test result based on the user information lookup.

It is to be understood that the foregoing general description and the following detailed description are exemplary and explanatory only and are not restrictive of the disclosed embodiments.

The following paragraphs, along with the accompanying drawings, describe the detailed technology and preferred embodiments of the present disclosure to enable a person skilled in the art to fully understand the claimed features.

### BRIEF DESCRIPTION OF FIGURES

The accompanying drawings, which are incorporated in and constitute a part of this specification, illustrate disclosed embodiments and, together with the description, serve to explain the disclosed embodiments.

FIG. 1 illustrates an exemplary scenario of testing user information in multiple data sources separately, consistent with disclosed embodiments.

FIG. 2 illustrates an exemplary scenario of testing user information in multiple data sources, consistent with disclosed embodiments.

FIG. 3 illustrates a schematic diagram of a system for testing user information, consistent with disclosed embodiments.

FIG. 4 illustrates an exemplary file recording user information, consistent with disclosed embodiments.

FIG. 5 illustrates an exemplary user information testing based on a test rule that users cannot be found in any source system, consistent with disclosed embodiments.

FIG. 6 illustrates an exemplary user information testing based on a test rule that users are found in a human capital reporting (HCR) data source, an identity management data source, and a service account (SA) data source, consistent with disclosed embodiments.

FIG. 7 illustrates an exemplary user information testing dashboard based on a test rule based on a user status, consistent with disclosed embodiments.

FIG. 8 illustrates an exemplary user information testing dashboard based on a test rule that users are found in the HCR data source with terminated status, consistent with disclosed embodiments.

FIG. 9 illustrates an exemplary user information testing dashboard based on a test rule that users are found in the SA data source, consistent with disclosed embodiments.

FIG. 10 illustrates an exemplary user information testing dashboard based on a test rule that users are found in an applicant data source, consistent with disclosed embodiments.

FIG. 11 illustrates an exemplary user information testing dashboard based on a test rule that users are associated with a change, consistent with disclosed embodiments.

FIG. 12 illustrates an exemplary user information testing dashboard based on a test rule that users are found in the identity management data source with transfer, consistent with disclosed embodiments.

FIG. 13 illustrates an exemplary dashboard, consistent with disclosed embodiments.

FIG. 14 illustrates a flow chart of an exemplary process for testing user information, consistent with disclosed embodiments.

FIG. 15 illustrates a flow chart of a second exemplary process for testing user information, consistent with disclosed embodiments.

FIG. 16 illustrates a flow chart of a third exemplary process for testing user information, consistent with disclosed embodiments.

### DETAILED DESCRIPTION

Reference will now be made in detail to exemplary embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limited.

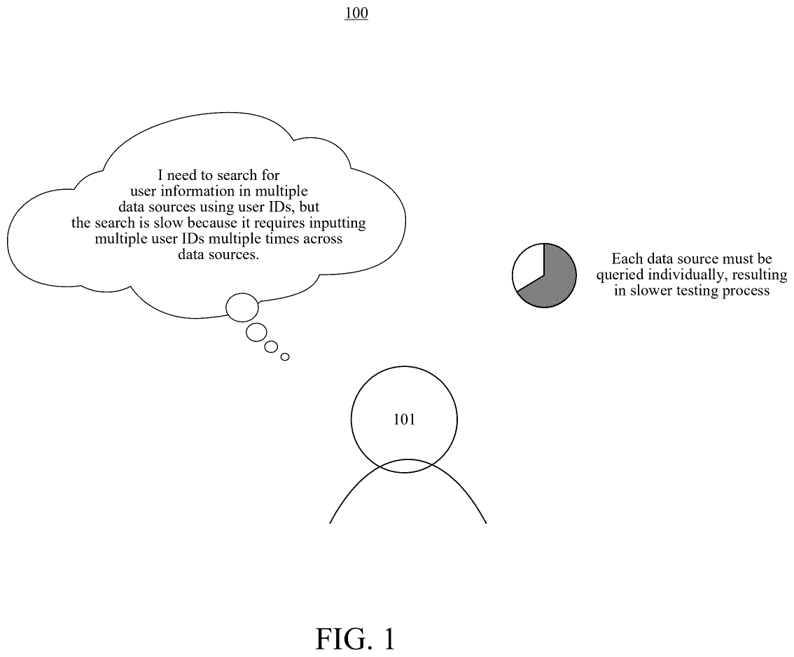

Reference is made to FIG. 1 which illustrates an exemplary scenario 100 of testing user information in multiple data sources 1051, 1052, 1053, 105n separately, consistent with disclosed embodiments. When a user 101 needs to query information related to a specific user identifier, e.g., user ID, employee ID, or email address, they must individually log in to data sources 1051, 1052, 1053, 105n to retrieve the information. In some embodiments, user 101 may refer to an auditor or other stakeholder in a company that needs access to user information. The user 101 may be an employee or contractor of an organization. In some embodiments, data sources may include a human resource management system, an identity management system, an application tracking system, a service account repository, or any other related data source. In some embodiments, the user may log on via a computing device 103. Computing device 103 may refer to any electronic device capable of processing, storing, and transmitting data, and executing software applications or services. This includes, but is not limited to, servers, desktop computers, laptops, tablets, smartphones, and virtual machines. A computing device may operate independently or as part of a networked system and is typically equipped with a processor, memory, input/output interfaces, and communication capabilities. In the described invention, computing devices are used to query, retrieve, and consolidate user identity and employment data from multiple enterprise systems.

User 101 may be required to input the identifier or email address that is registered in each data sources 1051, 1052, 1053, 105n on computing device 103 to retrieve data, download or export the query results from each data sources 1051, 1052, 1053, 105n separately. However, the process illustrated in FIG. 1 has multiple challenges because it requires accessing multiple separate and disparate data sources. This process may be time-consuming, and prone to human error. In addition, there may be fragmented or incomplete information because separate sources may only contain partial information or may not be up to date with the most accurate information. Errors may occur due to data mismatches, data duplication, or outdated data records. There may also be a lack of real-time insights of updates if data is not updated to reflect accuracy. Therefore, without prior integration or preprocessing of data sources 1051, 1052, 1053, 105n, querying user information is inefficient and time-consuming.

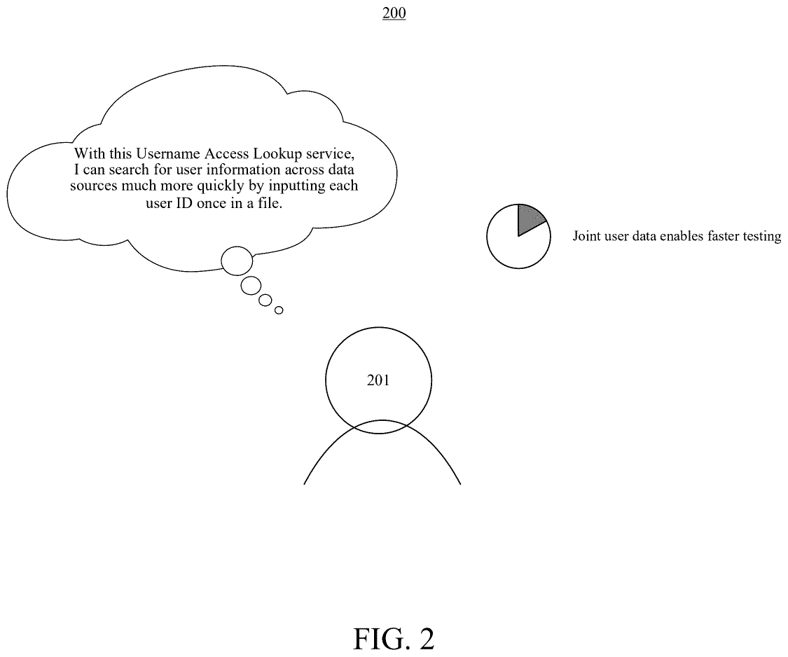

FIG. 2 illustrates an exemplary scenario 200 of testing user information in multiple data sources 2051, 2052, 2053, 205n, consistent with disclosed embodiments. In contrast to FIG. 1, the embodiment disclosed in FIG. 2 may combine the information about the user recorded in file 2031 and data sources 2051, 2052, 2053, 205n using a data join scheme to obtain joint user data 301. The “n” is used to denote that the number of data sources is not limited and may be variable depending on the implementations. Joint user data 301 may include one of the employee IDs corresponding to the user. System 300 may also search the user ID in joint user data 301 to obtain a search result, and generate a test result based on the search result and the test rule. Joint user data 301 may therefore contain, for each user identifier in file 2031, corresponding employee information (e.g., employee ID, account type, or employment status) retrieved from the connected data sources 2051, 2052, 2053, 205n. System 300 may search the user ID within joint user data 301 to obtain a search result, and generate a test result based on the search result and one or more test rules.

Accordingly, the present disclosure significantly improves query efficiency by simply revising file 2031 and also improves accuracy by preprocessing data sources 2051, 2052, 2053, 205n stored in database 205 by system 300. For example, data preprocessing may remove inconsistent or irrelevant data, leading to increased efficiency when using the data. User 201 may also prepare a file 2031 that records information about at least one user that is under tested. The information about the user may include a user ID or an email address.

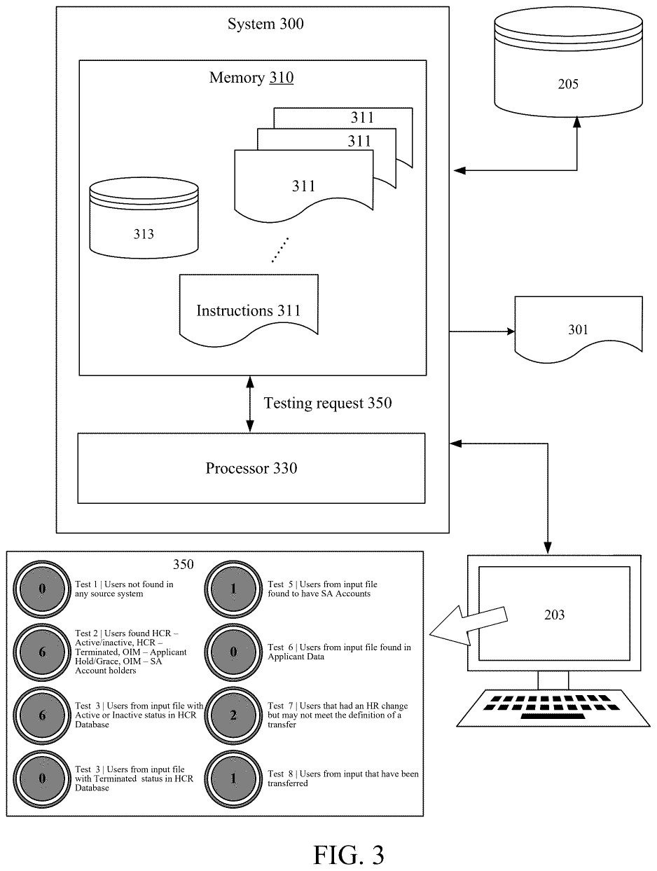

Reference is made to FIG. 3 which illustrates a block diagram of system 300 for testing user information, consistent with disclosed embodiments. System 300 may include a memory 310 and a processor 330. Memory 310 may store instructions 311. Memory 310 may include one or more storage devices configured to store instructions used by the processor 330 to perform functions related to a computing device, such as computing device 203. Computing device 203 may include one or more digital and/or analog devices that allow computing device to communicate with other machines or devices, such as other components of system 300. Computing device 203 may include one or more input/output devices. Computing device 203 may include a screen for displaying communications to a user. In some embodiments computing device 203 may include a touch screen. Computing device 203 may include other components known in the art for interacting with a user. Computing device 203 may also include one or more digital and/or analog devices that allow a user to interact with system 300, such as touch-sensitive area, keyboard, buttons, or microphones.

The disclosed embodiments are not limited to particular software programs or devices configured to perform dedicated tasks. For example, the memory 310 may store a single program, such as a user-level application, that performs the functions associated with the disclosed embodiments, or may comprise multiple software programs. Additionally, the processor 330 may, in some embodiments, execute one or more programs (or portions thereof) remotely located from computing device 203.

In some embodiments, memory 310 may include a database 313 as described herein. Database 313 may be included on a volatile or non-volatile, magnetic, semiconductor, tape, optical, removable, non-removable, or other type of storage device or tangible or non-transitory computer-readable medium. Database 313 may also be part of computing device 203 or separate from computing device 203. When database 313 is not part of computing device 203, computing device 203 may exchange data with database 313 via a communication link. Database 313 may include one or more memory devices that store data and instructions used to perform one or more features of the disclosed embodiments. Database 313 may include any suitable databases, ranging from small databases hosted on a work station to large databases distributed among data centers. Database 313 may also include any combination of one or more databases controlled by memory controller devices (e.g., server(s), etc.) or software. For example, database 313 may include document management systems, Microsoft SQL™ databases, SharePoint™ databases, Oracle™ databases, Sybase™ databases, other relational databases, or non-relational databases, such as mongo and others. In some embodiments, computing device 203 may include one or more input/output devices, communications devices, displays, and/or other interfaces (e.g., server-to-server, database to-to-database, or other network connections).

Furthermore, memory 310 may include one or more storage devices configured to store data for use by the programs. Memory 310 may include, but is not limited to a hard drive, a solid state drive, a CD-ROM drive, a peripheral storage device (e.g., an external hard drive, a USB drive, etc.), a network drive, a cloud storage device, or any other storage device.

Processor 330 may be communicatively connected to memory 310 and may execute instructions 311 to receive information about a user. Processor 330 may take the form of, but is not limited to, a microprocessor, embedded processor, or the like, or may be integrated in a system on a chip (SoC). Furthermore, according to some embodiments, processor 330 may be from the family of processors manufactured by Intel®, AMD®, Qualcomm®, Apple®, NVIDIA®, or the like. The processor 330 may also be based on the ARM architecture, a mobile processor, or a graphics processing unit, etc. The disclosed embodiments are not limited to any type of processor configured in computing device 203.

In some embodiments, instructions 311 may be executable instructions stored in memory 310. Processor 330 may perform one or more of the functions disclosed herein. Instructions 311 may include software code modules, firmware, microcode, or other logic stored on a non-transitory computer-readable medium. When executed, processor 330 may use instructions 311 to receive information about a user (e.g., a user identifier such as a user ID, email address, or service account ID) and perform preprocessing operations, such as removing duplicate entries, trimming extra spaces, and normalizing character case, to improve the accuracy of subsequent join operations.

In some embodiments, instructions 311 may further enable processor 330 to establish connections with one or more data sources, such as a human resources database, an identity management database, an applicant database, or a service account database, as described herein. Processor 330 may then perform a join operation between the user information and the selected data source based on common fields (e.g., user ID, email address, or logon ID) to generate a consolidated dataset of user information. The consolidated dataset may be used to execute multiple user information tests, such as verifying employment status, detecting service accounts, or identifying transfers.

Instructions 311 may additionally cause processor 330 to display results of the tests on a dashboard and to automatically refresh the dashboard in response to updates in the user information or the underlying data sources. In some embodiments, instructions 311 may include additional logic for enforcing security controls, validating permissions, recording audit logs, optimizing performance through caching, and exporting results in different formats.

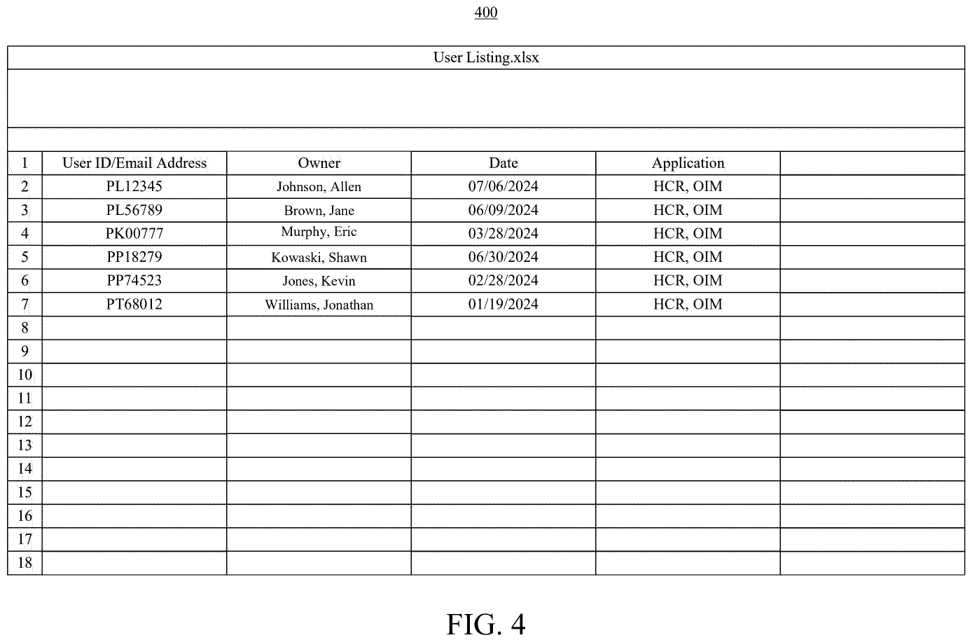

The information about the user may include a user ID or email address. Processor 330 may receive a testing request 350, where the testing request may refer to an instruction to evaluate user-related information recorded in a file, such as file 400 (described with respect to FIG. 4) against one or more predefined test rules using data obtained from one or more data sources. In some embodiments, a testing request 350 may specify which test or tests, e.g., active/inactive check, terminated check, service account check) are to be performed on the user identifier. The testing request therefore initiates a process to search the user identifier in the joint user data, apply the designated test rules, and generate corresponding test results that indicate whether the user meets the conditions defined by the rules. A testing request may refer to a request to initiate a process to evaluate, verify, or analyze user-related information, such as a user identifier (e.g., user ID, email address, or service account ID), against one or more predefined test rules using data obtained from one or more data sources. The testing request may initiate operations such as searching the identifier in joint user data, applying test rules, and generating corresponding test results.

The testing request 350 may be received from a user terminal. A user terminal may refer to a computing interface or device through which the user interacts with the disclosed system. Testing request 350 may include a test rule, information about a database 205, and a data source 2051, 2052, 2053, 205n stored in database 205. When testing information about the user, a user or an administrator of a company may specify which of the data sources should be evaluated. Accordingly, testing request 350 may include a test rule, information identifying the database, such as database 205, and information identifying one or more data sources, as described with respect to FIG. 2. A data source may refer to a virtual table, view, or schema within the database that stores employee-related information. In some embodiments, the test rule may define the logic and the conditions of the test to specify which test to run and define output requirements of the test.

Processor 330 may also be configured to retrieve data from a data source, as illustrated in FIG. 2. In some embodiments, the data sources may include a plurality of user identifiers (IDs). A data source, such as a table or a database view may contain multiple different fields. At least one of the fields may serve as the user ID. The user ID may uniquely represent a user or may be associated with a user. In some embodiments, a user identifier may be a unique data element assigned to an individual. The identifier may be a number or system-generated token that is used to link a user within the system to, for example, identity management platforms or access control logs. This identifier may be used to enable tracking of attributes or data.

In different data sources, the user ID may be a logon ID of a company, an email address, a service account, an applicant ID, or a human resource ID.

Processor 330 may also combine the information about the user and data sources using a data join scheme to obtain joint user data 301. The joint user data may include one of the plurality of employee IDs corresponding to the user. To be more specific, the joint user data may be the dataset produced by a join between the file and one or more data sources. System 300 may support different join types, e.g., left join, inner join, right join, full outer join. The system may also support relationships in the logical layer, and the chosen join type may determine which identifiers are presented in the result of the join—i.e. the joint user data. Because the same person may have multiple identifiers across systems, e.g., company logon ID, SA ID, Applicant ID, email, HR employee number, the joint user data may include one or more of those identifiers, but which ones appear may depend on the join type.

Processor 330 may also search the user ID in the joint user data to obtain a search result and generate a test result based on the search result and the test rule. In some embodiments, the test result may include at least the test rule applied and a corresponding outcome obtained from searching the designated data source(s) according to the test rule. Exemplary test rules are further described herein.

Processor 330 may further display the test result on a dashboard 350, and refresh the dashboard automatically in response to an update of the information about the user. The test result refers to the structured output of applying a test rule to a user identifier, such as whether the user identifier is found in a data source, or whether the user identifier is associated with an active, inactive, or terminated status. By displaying the test result on dashboard 350, system 300 may consolidate outputs from multiple data sources into a single user interface, reducing the likelihood of human error caused by manually accessing and reconciling different systems. Automatic refreshing may ensure that when the underlying user list or data sources are updated, the dashboard immediately reflects the most current information. This combination of automatic consolidation and refreshing improves accuracy by minimizing the use of outdated or incomplete records, improves efficiency by eliminating redundant manual queries, and enhances usability by presenting auditors with real-time results in a clear, visual format.

FIG. 4 illustrates an exemplary file 400 recording user information, consistent with disclosed embodiments. A processor, such as processor 330 may perform data visualization based on the file. Data visualization may refer to a graphical representation of information or data designed to make complex datasets easier to understand, analyze, and communicate. Data visualization may be used for clarity in visualization, increasing efficiency by interpreting large or complex information, and providing deeper analysis into insights for data by visualizing raw data. For example, a processor may upload a file, such as file 400 to a data visualization application and connect a workbook of the data visualization application to the information about the user recorded in file 400. A workbook may refer to a structured container within the visualization application that holds data tables, visual elements, or queries. The workbook may be connected to the data contained in file 400, such that the user information recorded in file 400 may be imported into a data table within the workbook.

As shown in FIG. 4, file 400 may be an Excel file or any other file capable of recording user information in a tabular format that includes multiple fields. The file 400 may record at least one of the user ID corresponding to a specific user, a name of the specific user, a date of the specific user being recorded, and an application that the specific user may be registered with. A processor may connect the workbook of the data visualization application to a database, consistent with disclosed embodiments.

A processor may be further configured to establish a connection to the information about the user and data sources stored in a database. This information may then be used to create a data join scheme, consistent with disclosed embodiments.

A processor may be further configured to operate the data visualization application to combine the information about the user and data sources using the data join scheme to obtain a joint user data. The data join scheme may be at least one of an inner join type, a left join type, a right join type, or a full outer join type. A data join scheme may refer to a structured method for combining data from multiple sources into a unified view. In some embodiments, a join clause may be used to specify which fields to use and how they should be matched. For example, an inner join may only match records from data sources. A left join may may retain all records from a first data source and include matching records from a second data source, while inserting null values where no match is found. A right join may retain all records from a second data source and include matching records from a first data source, while inserting null values where no match is found. A full outer join may retain all records from both sources and fill unmatched fields with null values, thereby producing a more comprehensive view of all records across the data sources. A processor may also be configured to receive a user input to define the data join scheme between the information about the user and the data source based on a common field between the information about the user and the data sources. In some embodiments, user input may allow the user to specify how the data should be joined.

Each data source may include a plurality of user IDs. In some embodiments, the joint user data may include a user ID that corresponds to a specific user. A processor may also be configured to search the user ID, as recorded in a file, such as file 400 to obtain a search result and generate a test result based on the search result and test rule. The test result may be generated by evaluating the search result retrieved from designated data sources against one or more predefined test rules, and outputs a structured result. For example, when the search result indicates that a user identifier exists in an active/inactive employee data source and the test rule is configured to determine whether the user is currently employed, the test result may classify the user as active or inactive. In another example, when the search result indicates that the user identifier exists in the data source that includes terminated user information, and the test rule specifies verifying termination status, the test result may output “terminated.”

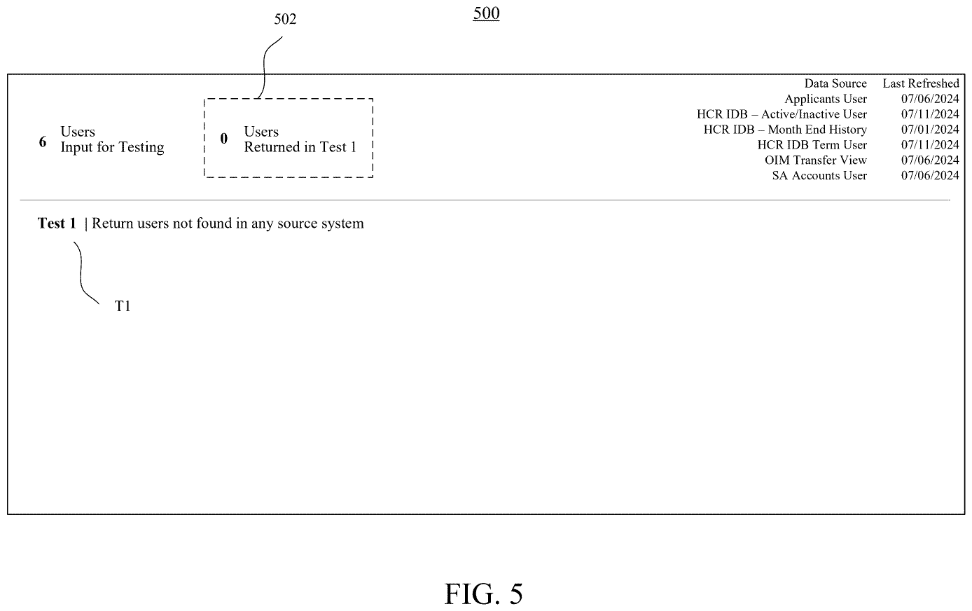

In some embodiments, the test rule includes testing the data source to determine whether the user ID is absent. For example, reference is made to FIG. 5 which illustrates an exemplary user information testing based on a test rule T1. Test rule T1 illustrates that users cannot be found in any source system, consistent with disclosed embodiments. In some embodiments, a processor may be configured to perform a search query in a data source based on the user ID. In some embodiments, a processor may determine whether the user ID is found in the data source based on the search. If a user ID is not found, the processor may return a missing user ID and display the number of the missing user IDs on the dashboard, as illustrated in FIG. 5. In some embodiments, a missing user ID may indicate that the queried identifier does not exist in the system, that the identifier exists but may be stored differently based on a different format or alias, or that there is a missing identifier because of outdated or incorrect records. In alternative embodiments, the processor may determine that the user ID is found in the listed data sources. In such cases, the processor may return as search result 502 corresponding to test rule T1.

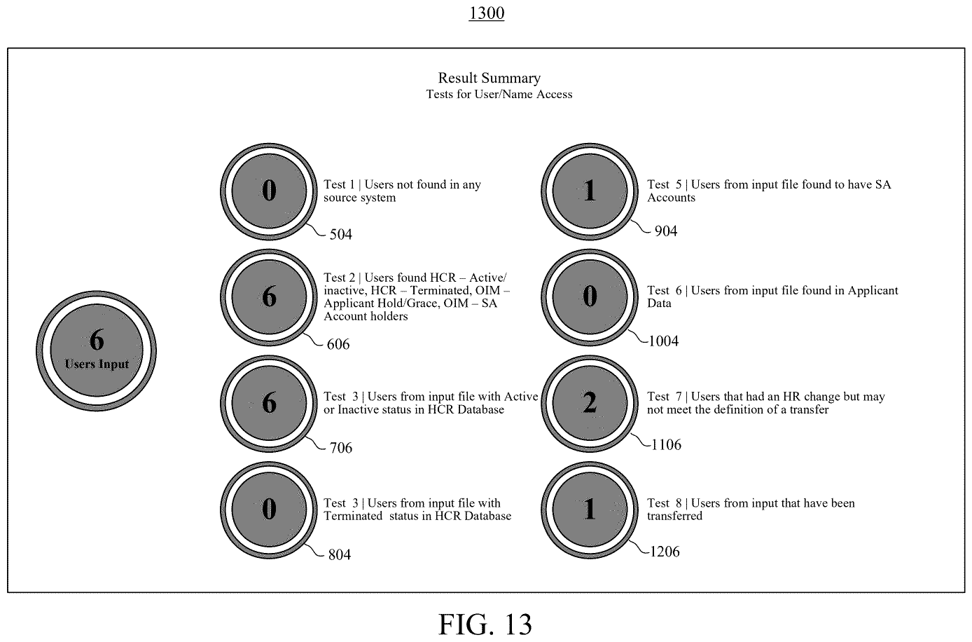

As shown in FIG. 5, test rule T1 may be defined as testing the data source to determine whether the user ID is absent. In other words, when testing the information about the user recorded in a file, the processor may perform a search query in the data sources. As illustrated in FIG. 5, data sources may be listed on a dashboard in the upper right hand corner. In some embodiments, if a user ID is not found in the listed data sources, the processor may be further configured to expand the search to other data sources. Although this information is described with respect to FIG. 5, it may apply to any of the dashboards described herein. A processor may then generate a test result based on a search result using the test rule T1. Such a test result may be display on a dashboard, as further described with respect to FIG. 13.

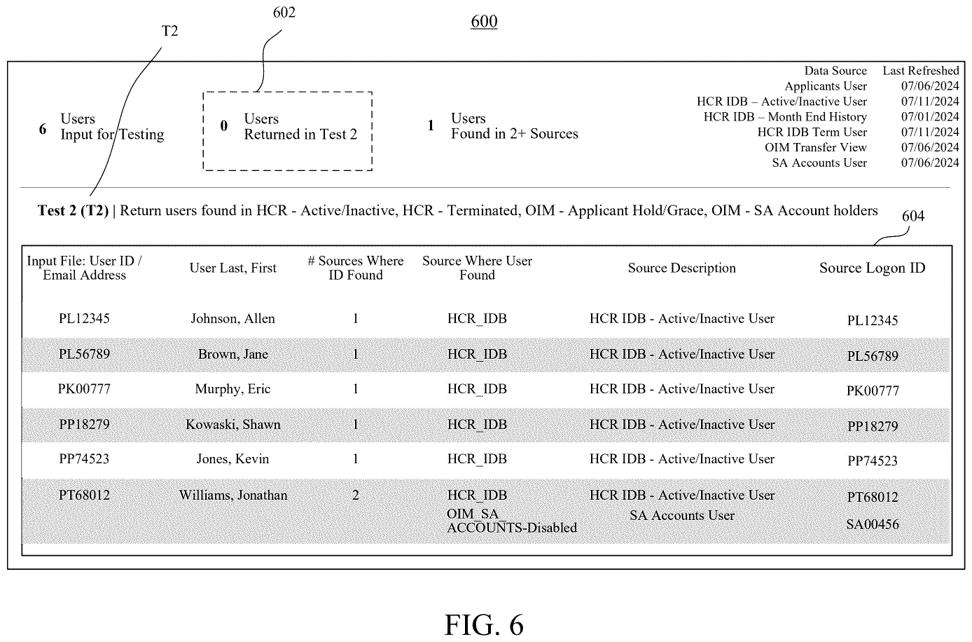

FIG. 6 illustrates an exemplary dashboard 600 for test rule T2. Test rule T2 indicates that users are found in a human capital reporting (HCR) data source, an identity management data source, and a service account (SA) data source, consistent with disclosed embodiments. Test rule T2 may include testing that the user ID exists in at least one of the data sources.

When testing the information about the user, a processor may perform a search query in the data sources using the user ID and determine whether the user ID is found in the data source. If the processor obtains the queried user IDs, it may display the number of found user IDs on the dashboard, as illustrated in FIG. 6. In some embodiments, testing the information may refer to using the user IDs recorded in a file and confirming whether each of those user IDs are found in a data source, consistent with disclosed embodiments.

As shown in FIG. 6, test rule T2 may be defined as testing the information about the user recorded in a file that may be associated with the data sources. In some embodiments, when testing the information, the processor may perform a search query in the data sources listed in the upper right corner of the dashboard, as shown in FIG. 6.

As illustrated in FIG. 6, the dashboard 600 may be further configured to display a table that includes detailed search results 604 corresponding to the information about the user. For example, as illustrated in FIG. 6, “AB66213” is the user ID of the username “Johnson, Allen”. The format of the username may be shown as the last name before the first name. Detailed search results 604 may also show the number of the data sources in which the user ID can be found, which data source(s) in which the user ID is found, and the corresponding description of the data source.

As illustrated in FIG. 6, for each user ID “AB66213,” “AC74239,” “AC41526,” “AD85216,” and “AD14638,” they may be found in one data source “HCR_IDB.” For user ID “AB35789,” it may be found in two data sources, “HCR_IDB” and “OIM_SA_ACCOUNTS-Disabled”. The source logon ID is the ID that is used in the corresponding data source. In some embodiments, the source logon ID may refer to an ID recorded in the data sources. In some embodiments, the source logon ID may refer to a user ID recorded in a file. In some embodiments, the source logon ID may be associated with a user ID.

As illustrated in FIG. 6, because all information the user recorded in the file was found in one of the listed data sources, the dashboard may display the number 6 as search result 602 corresponding to test rule T2.

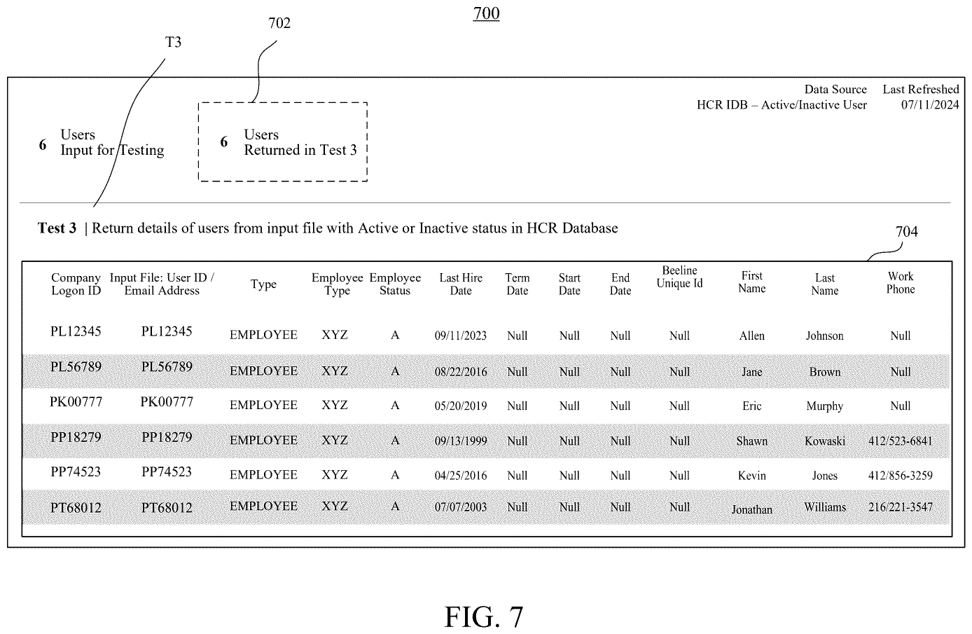

FIG. 7 illustrates an exemplary dashboard 700 for test rule T3, consistent with disclosed embodiments. In some embodiments, test rule T3 may include testing a status information corresponding to the user ID in the data source. The status information may include an active status and an inactive status. A processor may be configured to perform a search query in the data source using the user ID and obtain status information associated with the user ID. In some embodiments, a processor may obtain a number of the user ID associated with the status information. Such information may be displayed on a dashboard, as further illustrated in FIG. 13.

As shown in FIG. 7, test rule T3 may be defined as testing the active or inactive status of the information about the user recorded in a file associated with the user. For example, as illustrated in FIG. 7, “PL12345” is the user ID of the username “Johnson, Allen.” The format of the username may be shown with the first name before the last name. Detailed search results 704 may also show additional attributes associated with the user ID, including type, employee type, employee status, last hire date, termination date, start date, end date, Beeline unique ID, and contact information such as work phone.

As illustrated in FIG. 7, for each user ID “PL12345,” “PL56789,” “PK00777,” “PP18279,” “PP74523,” and “PT68012” they may be found in one data source “HCR_IDB.” The company logon ID is the ID that is used in the corresponding data source. In some embodiments, the company logon ID may refer to an ID recorded in the data sources. In some embodiments, the company logon ID may refer to a user ID recorded in a file. In some embodiments, the company logon ID may be associated with a user ID.

As illustrated in FIG. 7, detailed search result 704 may show a table that includes multiple fields related to the user ID and the associated status. For example, in the employee status field of the table, the status “A” represents that the user ID is active. The other elements of the table may be similar or the same as those described with respect to FIG. 6.

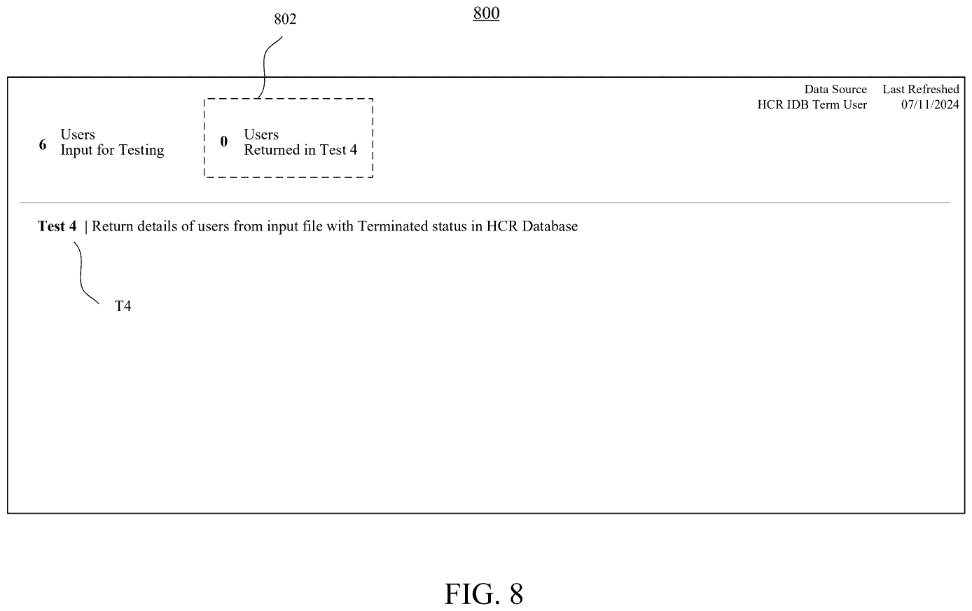

FIG. 8 illustrates an exemplary dashboard 800 for test rule T4, consistent with disclosed embodiments. Test rule T4 may be used to test information related to a terminated status. In some embodiments, a processor may perform a search query in the data sources to determine additional information related to a potential terminated status.

The data source listed in the upper right corner of dashboard 800 includes “HCR_IDB_Term User”. The data source “HCR_IDB_Term User” may record users that are in terminated status.

In some embodiments, the status information may further include a terminated status. As shown in FIG. 8, test rule T4 may be defined as testing the terminated status of the information about the user recorded in a file. As shown in FIG. 8, a processor may determine that none of the user IDs recorded in the file is in the terminated status and return the number 0 as show in search result 802.

In some embodiments, the identity management database may include a service account (SA) file recording an access right of the user. Processor 330 may perform a search query in the SA file using the user ID. Processor 330 may also be configured to determine whether the user ID is found in the SA file. Upon determining the user ID is found in the SA file, the processor may also be configured to obtain a number of the user ID that is found in the SA file and display the number of the found user ID on the dashboard.

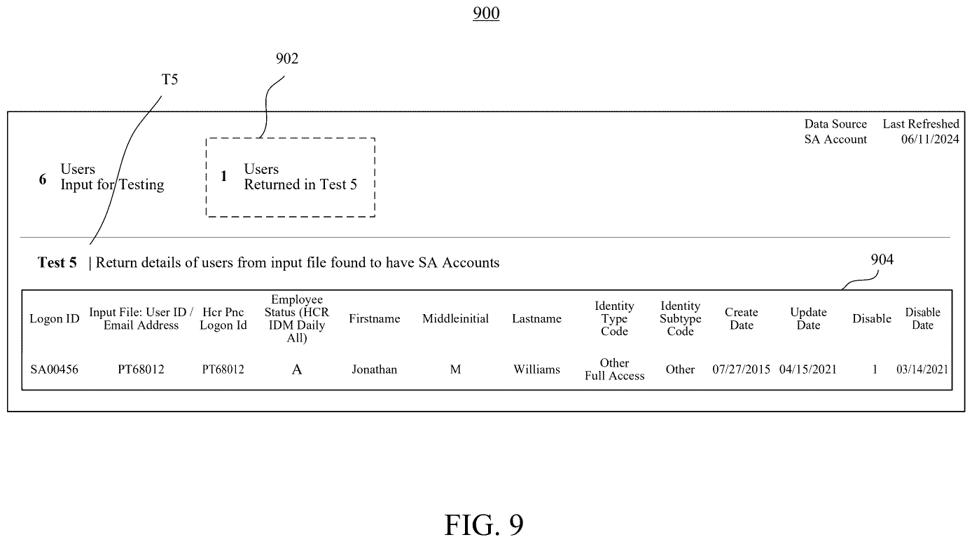

FIG. 9 illustrates an exemplary dashboard 900 for test rule T5, consistent with disclosed embodiments. Test rule T5 may be defined as testing the user IDs recorded in file 2301 in the data source listed at upper right corner and determine whether any user ID is recorded in the data source. The listed data source includes “SA Account User.” In other words, “SA Account User” data source is the only one data source that is designated to be searched in test 5. When testing the information about the user recorded in file 2031, processor 330 may perform a search query in the data source “SA Account User.” Since there is only one user found in the data source “SA Acount User”, processor 330 may return 1 user and show the corresponding details of the found user.

As shown in FIG. 9, processor 330 may display a detailed search result 904 corresponding to the user ID. Among 6 user IDs that are recorded in file 2301, only user ID “PT68012” is found in the data source “SA Account User” and shown in detailed search result 904. Processor 330 may show the number 1 of the found user ID as search resuly 902, and generate test result 906 based on the search result 902 and test rule T5.

A service account (SA) may be typically not a personal login account. Instead, it is used by applications, background services, batch jobs, system integrations, or automated processes to access resources. An SA account user may be the owner or responsible person linked to that service account. For example, the account's owner, responsible person, or administrator.

In some embodiments, the identity management data source may include an applicant data file recording an access right of the user. When testing the information about the user, processor 330 may perform a search query in the applicant data file using the user ID. The processor may also be configured to determine whether the user ID is found in the applicant data file. Upon determining the user ID is found in the applicant data file, processor 330 may also obtain a number of the user ID that is found in the applicant data file and display the number of the found user ID on the dashboard.

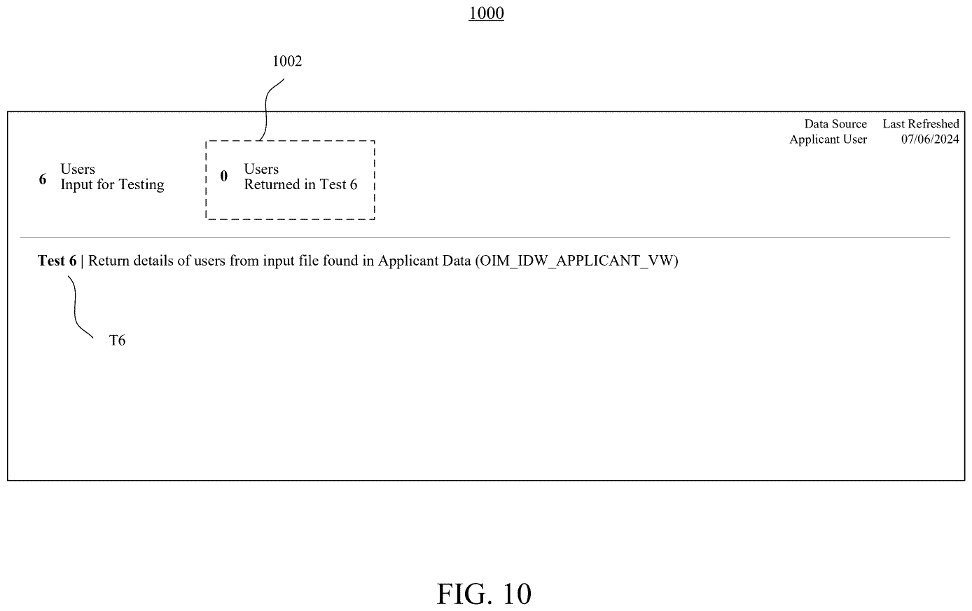

FIG. 10 illustrates an exemplary dashboard 1000 for test rule T6. Test rule T6 indicates whether a user is found in “Applicant User” data source, consistent with disclosed embodiments. Test rule T6 may include testing the user ID exists in the data source “Applicant User.”

When testing the information about the user, a processor may perform a search query in the data source “Applicant User” using the user ID and determine whether the user ID is found in the data source. If the processor obtains the queried user IDs, it may be configured to display the number of found user IDs on the dashboard, as illustrated in FIG. 10. In some embodiments, testing the information may refer to using the user IDs recorded in a file and confirming whether each of those user IDs are found in a data source, consistent with disclosed embodiments.

An applicant user may refer to a user account associated with a job applicant rather than a current employee. These records may still have user IDs, email addresses, or temporary accounts within internal systems. For example, to allow the applicant to log into an application portal or complete pre-hire processes.

As shown in FIG. 10, among 6 user IDs input for testing, none of the user IDs was found in the data source “Applicant User”. Therefore, the number 0 of the found user ID as search result 1002 is returned. Because no information regarding the user recorded in the file was found in one of the listed data sources, the dashboard may display the number 0 as search result 1002, corresponding to test rule T6.

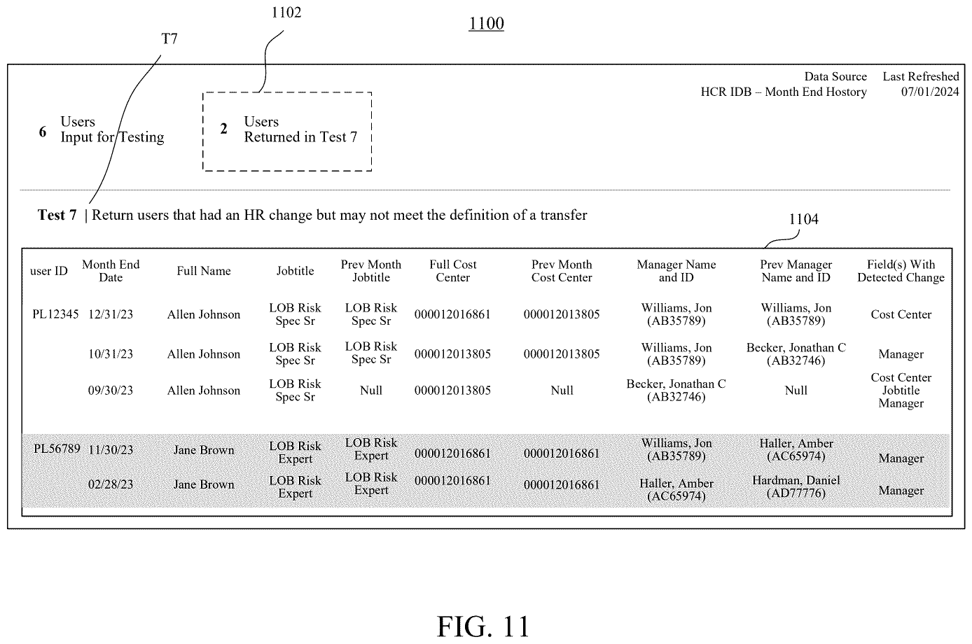

As shown in FIG. 11, test rule T7 may be defined as testing the information about the user recorded in a file that may be associated with the data sources. In some embodiments, when testing the information, the processor may perform a search query in the data sources listed in the upper right corner of the dashboard, as shown in FIG. 10.

As illustrated in FIG. 11, the dashboard 1100 may be further configured to display a table that includes detailed search results 1104 corresponding to the information about the user. For example, as illustrated in FIG. 11, “PL12345” is the user ID of the username “Allen Johnson”. “PL56789” is the user ID of the username “Jane Brown”. For each user ID “PL12345” and “PL56789,” they may be found in one data source “HCR_IDB—Month End History.” Detailed search results 1104 may also show the number of the data sources in which the user ID can be found, which data source in which the user ID is found, and the corresponding description of the data source.

Please refer to FIG. 11. Test rule T7 may be defined as testing the user IDs having an human resource (HR) change in the data source “HCR IDB” listed at upper right corner.

A processor may further determine whether the found user IDs have a job transfer. The job transfer may include having a job title that is different from the previous job title, having a cost center number that is different from the previous cost center number, or having a manager name or ID that is different from the previous manager name or ID. If the found user ID includes the job transfer, processor may also show a field with detected change in detailed search result 1104.

As shown in FIG. 11, user ID “PL12345” is listed in detailed search result 1104 because processor 330 detects that the cost center and the previous cost center is changed. User ID “PL56789” is also listed in detailed search result 1104 because processor 330 detects that the manager name or ID and the previous manager name or ID is changed.

As illustrated in FIG. 11, the processor may return the number 2 of the found user ID as search result 1102 and generate test result 1106 based on the search result 1102 and test rule T7. Such information may be displayed on a dashboard, as further illustrated in FIG. 13.

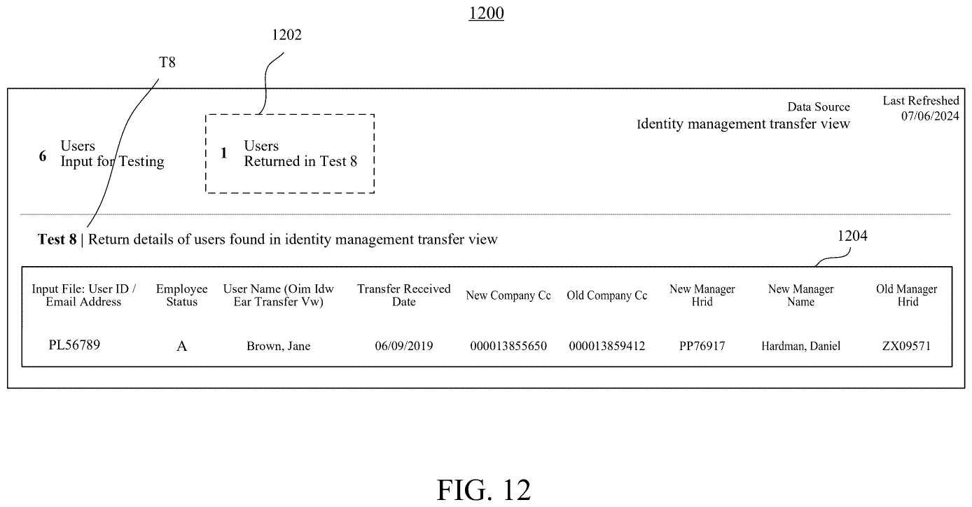

FIG. 12 illustrates an exemplary dashboard 1200 for test rule T8. Test rule T8 indicates that users are found in an identity management transfer view data source, consistent with disclosed embodiments. Test rule T8 may include testing whether the user ID exists in the data source including an identity management transfer.

When testing the information about the user, a processor may perform a search query in the data sources using the user ID and determine whether the user ID is found in the data source. If the processor obtains the queried user IDs, it may display the number of found user IDs on the dashboard, as illustrated in FIG. 12. In some embodiments, testing the information may refer to using the user IDs recorded in a file and confirming whether each of those user IDs are found in a data source, consistent with disclosed embodiments.

As shown in FIG. 12, test rule T8 may be defined as testing the information about the user recorded in a file that may be associated with the data sources. In some embodiments, when testing the information, the processor may perform a search query in the data sources listed in the upper right corner of the dashboard, as shown in FIG. 12.

As illustrated in FIG. 12, the dashboard 1200 may be further configured to display a table that includes detailed search results 1204 corresponding to the information about the user. For example, as illustrated in FIG. 12, “PL56789” is the user ID of the username “Brown, Jane”. The format of the username may be shown as the last name before the first name. Detailed search results 1204 may also show the number of the data sources in which the user ID can be found, which data source in which the user ID is found, and the corresponding description of the data source.

As illustrated in FIG. 12, for each user ID “PL56789,” the user ID may be found in one data source “identity management transfer view.” Because only one result for the user recorded in the file was found in one of the listed data sources, the dashboard may display the number 1 as search result 1202, corresponding to test rule T8.

FIG. 13 illustrates a summary dashboard 1300 for test rules T1, T2, T3, T4, T5, T6, T7, T8, consistent with disclosed embodiments. An end user may provide a list of user IDs through a file. The file may be stored on a shared drive for convenient access. Once uploaded, dashboard 1300 shown in FIG. 13 may automatically refresh and run a sequence of test rules corresponding to predefined tests against multiple data sources. Each test has a distinct objective to validate, classify, or trace the status of the users corresponding to the user IDs listed in the file.

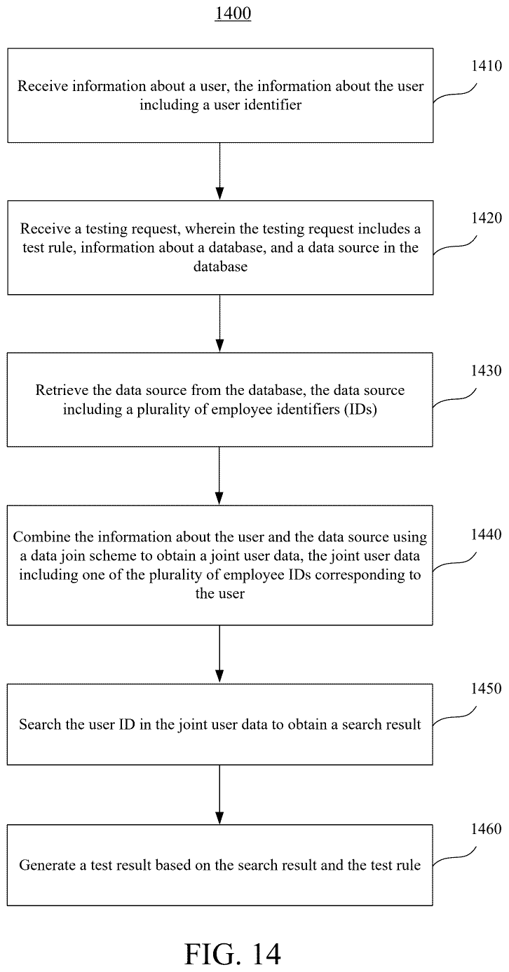

FIG. 14 illustrates a flow chart of an exemplary process 1400 for testing user information according to some embodiments of the present disclosure. Process 1400 may include receiving information about a user (step 1410). The information about the user may include a user ID. Process 1400 may also include receiving a testing request (step 1420). The testing request may include a test rule, information about a database, and a data source in the database.

A test rule may refer to a condition, logic, or instruction that specifies how information about a user recorded in the file should be compared against one or more employee ID or logon ID in data sources. A test rule may define the scope of the query, the type of comparison, and the expected output, e.g., returning users not found in any data source, or returning users with an active status.

Information about a database may refer to metadata, configuration data, or descriptive data that characterizes the database. Such information may include the type of the database, e.g., relational or non-relational, the structure of the database, the names and formats of tables or fields, and connection information that enables queries to be executed against the database.

A data source in the database may refer to a specific collection, virtual table, or view within the database from which data can be retrieved. A data source may include user identifiers, attributes, or records, and may be distinguished from other data sources by its schema, data type, or functional role.

Process 1400 may also include retrieving the data source from the database (step 1430). The data source may include a plurality of user identifiers (IDs). Process 1400 may also include combining the information about the user and the data source using a data join scheme to obtain joint user data (step 1440). The joint user data may include one of the plurality of user IDs corresponding to the user. A data join scheme may refer to a relational database operation, e.g., an inner join, left join, or outer join, or an equivalent data matching procedure that associates user IDs from the file, e.g., excel file with corresponding identifiers stored in one or more data sources. The joint user data may represent the merged record set that results from aligning a user ID from the file with an employee ID or logon ID contained in the data source. For example, the processor may use the user ID “PL12345” from the Excel input file and join it with records in the HCR_IDB data source to return additional attributes, such as employee name, status, or department. Thus, the joint user data not only verifies the presence or absence of the user ID in a given data source but also provides a consolidated view of the attributes associated with that user across different data sources.

Process 1400 may also include searching for the user ID in the joint user data to obtain a search result (step 1450). This searching may refer to querying the joint user data, i.e., the merged record set produced by joining the input file of user IDs with one or more data sources so as to determine presence, location, and attributes associated with a given user ID.

Process 1400 may also include generating a test result based on the search result and the test rule (step 1460). In some embodiments, generating a test result based on the search result and the test rule may include evaluating whether the outcome of searching the joint user data satisfies a condition defined by the test rule, consistent with disclosed embodiments. For example, the search result may indicate whether a user ID from the file is present in one or more data sources and, if present, which data source(s) contain the user ID and what attributes are associated with that user.

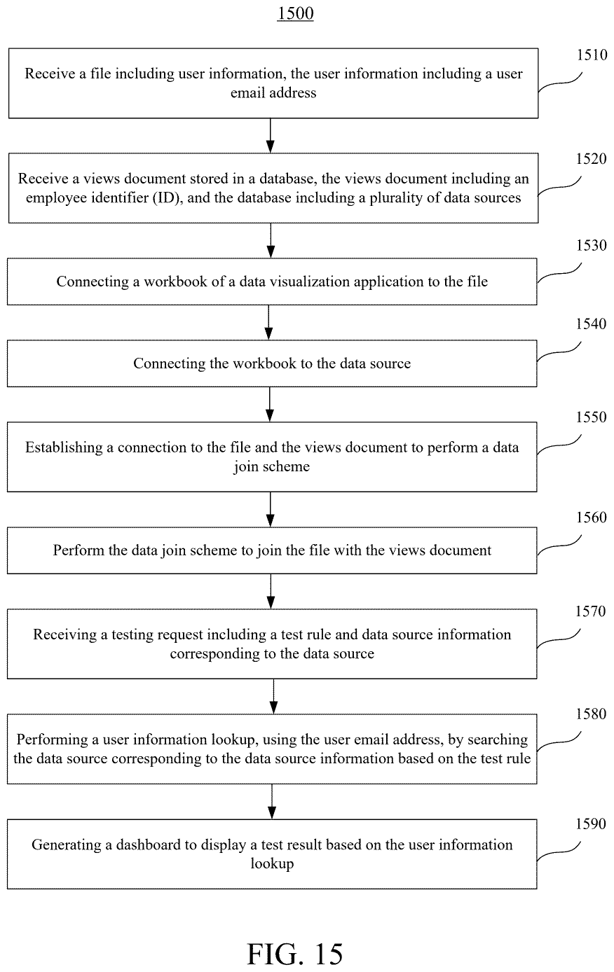

Reference is made to FIG. 15 which illustrates a flow chart of an exemplary process 1500 for testing user information according to some embodiments of the present disclosure. Process 1500 may be performed by system 300 in FIG. 3. Process 1500 may include receiving a file including user information (step 1510). The user information may include a user email address.

Process 1500 may also include receiving a virtual table stored in a database (step 1520). The virtual table may include an employee identifier (ID). The database may include a plurality of data sources. The virtual table refers to a logical table generated by a database, commonly known as a view. A virtual table does not store data itself, but rather represents the results of a predefined query that combines or filters data from one or more underlying physical tables. When a virtual table is accessed, the database dynamically retrieves the relevant data from the underlying tables according to the query definition. Thus, a virtual table provides an interface similar to a conventional table while relying on other tables as its actual data source. The virtual table may define a schema that specifies how user identifiers in the input file can be associated with employee identifiers in the database, thereby enabling subsequent data joins. Process 1500 may also include connecting a workbook of a data visualization application to the file (step 1530). Process 1500 may also include connecting the workbook to the data source (step 1540). This connection may allow the workbook to access the database and execute queries across multiple data sources.

Process 1500 may also include establishing a connection to the file and the virtual table to perform a data join scheme (step 1550). The file may contain user-related identifiers, such as user IDs or email addresses, while the virtual table, e.g., a database view may include employee attributes such as employment status, account type, or applicant information. A processor may use one or more APIs, drivers, or connectors to access both sources simultaneously. The processor may apply a data join scheme, e.g., inner join, left join, right join, or full outer join to align common fields between the file and the virtual table. For example, a user ID from the file may be matched with a corresponding logon ID or email address in the virtual table. The join operation produces joint user data, which consolidates identifiers from the file with the virtual table stored in the database.

Process 1500 may also include performing the data join scheme to join the file with the virtual table (step 1560). The data join scheme may include an inner join, left join, or outer join that aligns the user email addresses from the file with corresponding employee identifiers in the virtual table. The output of this step may produce a joint user data set that consolidates attributes from both the file and the database. Process 1500 may also include receiving a testing request including a test rule and data source information corresponding to the data source (step 1570). The testing request may specify logical criteria, such as returning users not found in any data source, returning users found in at least one data source, or returning detailed user attributes from a specific source.

Process 1500 may also include performing a user information lookup, using the user email address, by searching the data source corresponding to the data source information based on the test rule (step 1580). The user information lookup may normalize the input identifier, query one or more data sources, and determine whether the user email address is present, and if so, retrieve corresponding attributes such as employee type or status. Process 1500 may also include generating a dashboard to display a test result based on the user information lookup (step 1590). The dashboard may provide a visual interface that consolidates test results and detailed records, allowing an end user, e.g., an auditor or an administrator to quickly interpret the outcomes of the testing process. In some embodiments, the generated dashboard may be updated on an iterative basis or in real time based on updated information.

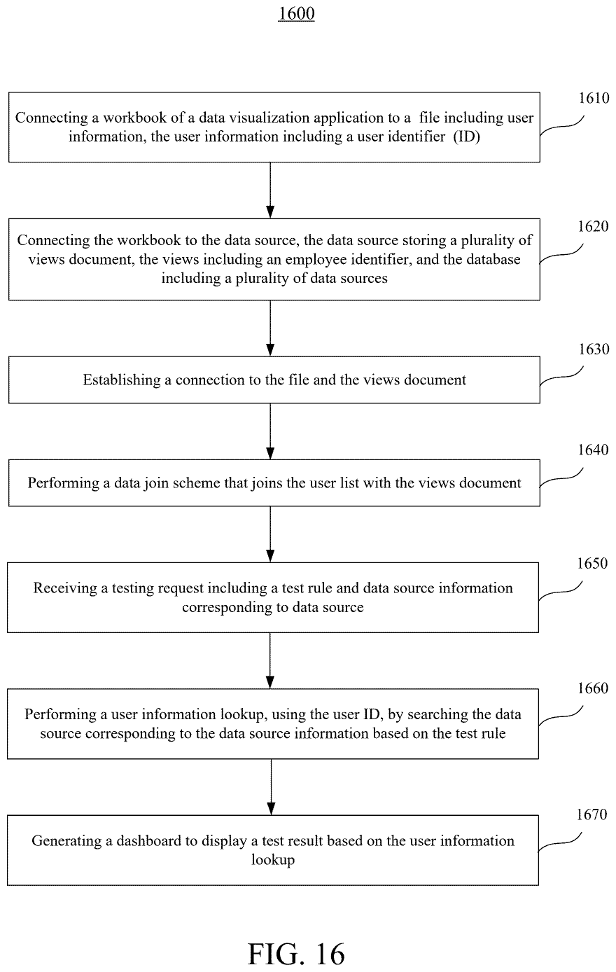

Reference is made to FIG. 16, which illustrates a flow chart of an exemplary process 1600 for testing user information according to some embodiments of the present disclosure. Process 1600 may be performed by system 300 as illustrated in FIG. 3. Process 1600 may include connecting a workbook of a data visualization application to a file including user information. The user information may include a user identifier (ID) (step 1610). Process 1600 may also include connecting the workbook to the data source (step 1620). The workbook may refer to a structured container within the visualization application, that holds data tables, queries, and visual elements. The data source may store a plurality of virtual tables. The virtual tables may include an employee identifier. The database may include a plurality of data sources. When connecting to a file, such as an Excel spreadsheet containing user IDs, the workbook may parse the file to identify relevant columns, e.g., “user ID” or “email address”). When connecting to a virtual table in the database, the workbook may execute a predefined query or view definition to retrieve user attributes, e.g., employment status. The connection process thus allows the workbook to access both types of data and apply a join operation.

Process 1600 may include establishing a connection to the file and the virtual table (step 1630). The virtual tables may provide different logical representations of the underlying data, enabling user identifiers from the file to be matched against multiple data sources in a consistent manner. Process 1600 may also include performing a data join scheme that joins the user list with the virtual table (step 1640).

Process 1600 may also include receiving a testing request (step 1650). The testing request may include a test rule and data source information corresponding to data source. The test rule may indicate whether to identify missing users, verify active or inactive status, or retrieve detailed employment records.

Process 1600 may also include performing a user information lookup, using the user ID, by searching the data source corresponding to the data source information based on the test rule (step 1660). Step 1660 may involve determining whether a record corresponding to a user ID from the Excel input file exists in the specified data source. The lookup may further involve retrieving associated attributes of the matching record, such as employee type, status, or hire date, depending on the applicable test rule. Process 1600 may also include generating a dashboard to display a test result based on the user information lookup (step 1670).

Those skilled in the art should understand that the embodiments of the present disclosure can be provided as a method, a system, or a computer program product. Accordingly, the present disclosure can take the form of an entirely hardware embodiment, an entirely software embodiment, or some embodiments combining software and hardware. Moreover, the embodiments of the present disclosure can take the form of a computer program product implemented on one or more computer usable storage media (including, but not limited to, disk memories, CD-ROMs, optical memories, etc.) comprising computer usable program codes.

The present disclosure is described with reference to the flowcharts and/or the block diagrams of a method, a device (system), and a computer program product according to the embodiments of the present disclosure. It should be understood that each process and/or block in the flowcharts and/or block diagrams, as well as combinations of the processes and/or blocks in the flowcharts and/or the block diagrams, can be implemented by computer program instructions. These computer program instructions can be provided to a processor of a computer, an embedded processor, or other programmable data processing devices to produce a machine such that an apparatus for implementing the functions specified in one or more processes in the flowcharts and/or one or more blocks in the block diagrams can be produced by instructions executed by the processor of the computer or other programmable data processing devices.

These computer program instructions can also be stored in a computer readable memory that can direct a computer or other programmable data processing devices to function in a particular manner such that the instructions stored in the computer readable memory produce an article of manufacture including an instruction means that implements functions specified in one or more processes in the flowcharts and/or one or more blocks in the block diagrams.

These computer program instructions can also be loaded onto a computer or other programmable data processing devices so that a series of operating steps are performed on the computer or other programmable devices to produce computer-implemented processing. Thus, the instructions executed on a computer or other programmable devices provide steps for implementing the functions specified in one or more processes in the flowcharts and/or one or more blocks in the block diagrams.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed:

1. A system for testing user information, the system comprising:
a memory configured to store instructions; and
a processor communicatively connected to the memory and configured to execute the instructions to:
receive information about a user, the information about the user including a user identifier (ID);
receive a testing request, wherein the testing request includes a test rule, information about a database, and a data source in the database;
retrieve the data source from the database, the data source including a plurality of employee identifiers (IDs);
combine the information about the user and the data source using a data join scheme to obtain a joint user data, the joint user data including one of the plurality of employee IDs corresponding to the user;
search the user ID in the joint user data to obtain a search result; and
generate a test result based on the search result and the test rule.

2. The system of claim 1, wherein the processor is further configured to execute the instructions to:
display the test result on a dashboard; and
refresh the dashboard automatically in response to an update of the information about the user.

3. The system of claim 2, wherein when testing the information about the user, the processor is further configured to execute the instructions to:
perform a search query in the data source using the user ID;
determine whether the user ID is found in the data sources;
return a number of a missing user ID that is not found in the data source; and
display the number of the missing user ID on the dashboard.

4. The system of claim 2, wherein the data source includes a human capital reporting (HCR) data source and an identity management data source.

5. The system of claim 4, wherein the test rule includes testing the user ID exists in at least one of the HCR data source and the identity management data source.

6. The system of claim 5, wherein the processor is further configured to execute the instructions to:
perform a search query in the HCR data source and the identity management data source using the user ID;
determine whether the user ID is found in at least one of the HCR data source and the identity management data source;
obtain a number of a found user ID; and
display the number of the found user ID on the dashboard.

7. The system of claim 4, wherein the test rule includes testing a status information corresponding to the user ID in the HCR data source.

8. The system of claim 7, wherein the status information includes an active status and an inactive status, when testing the information about the user, the processor is further configured to execute the instructions to:
perform a search query in the HCR data source using the user ID;
obtain the status information corresponding to the user ID;
obtain a number of the user ID with the status information; and
display the number of the found user ID on the dashboard.

9. The system of claim 7, wherein the status information further includes a terminated status.

10. The system of claim 4, wherein the identity management database includes a service account (SA) file recording an access right of the user.

11. The system of claim 10, wherein the processor is further configured to execute the instructions to:
perform a search query in the SA file using the user ID;
determine whether the user ID is found in the SA file;
upon determining the user ID is found in the SA file, obtain a number of the user ID that is found in the SA file; and
display the number of the found user ID on the dashboard.

12. The system of claim 4, wherein the identity management data source includes an applicant data file recording an access right of the user.

13. The system of claim 10, wherein when testing the information about the user, the processor is further configured to execute the instructions to:
perform a search query in the applicant data file using the user ID;
determine whether the user ID is found in the applicant data file;
upon determining the user ID is found in the applicant data file, obtain a number of the user ID that is found in the applicant data file; and
display the number of the found user ID on the dashboard.

14. The system of claim 1, wherein the information about the user further includes a user email address.

15. The system of claim 1, wherein the processor is further configured to execute the instructions to:
connect a workbook of a data visualization application to the information about the user;
connect the workbook to the database; and
establish a connection to the information about the user and the data source for the data join scheme.

16. The system of claim 1, wherein the processor is further configured to execute the instructions to:
receive a user input to define the data join scheme between the information about the user and the data source based a common field between the information about the user and the data source.

17. The system of claim 1, wherein the data join scheme is at least one of an inner join type, a left join type, a right join type, or a full outer join type.

18. The system of claim 1, wherein the test rule includes testing the data source to determine whether the user ID is absent.

19. A computer-implemented method for testing information about a user, the method performed by at least one processor, the method comprising:
receiving a file including user information, the user information including a user email address;
receiving a virtual table stored in a database, the virtual table including an employee identifier (ID), and the database including a plurality of data sources;
connecting a workbook of a data visualization application to the file;
connecting the workbook to the data source;
establishing a connection to the file and the virtual table to perform a data join scheme;
performing the data join scheme to join the file with the virtual table;
receiving a testing request including a test rule and data source information corresponding to the data source;
performing a user information lookup, using the user email address, by searching the data source corresponding to the data source information based on the test rule; and
generating a dashboard to display a test result based on the user information lookup.

20. A computer-implemented method for testing information about a user, the method performed by at least one processor, the method comprising:
connecting a workbook of a data visualization application to a file including user information, the user information including a user identifier (ID);
connecting the workbook to the data source, the data source storing a plurality of virtual table, the virtual table including an employee identifier, and the database including a plurality of data sources;
establishing a connection to the file and the virtual table;
performing a data join scheme that joins the user list with the virtual table;
receiving a testing request including a test rule and data source information corresponding to data source;
performing a user information lookup, using the user ID, by searching the data source corresponding to the data source information based on the test rule; and
generating a dashboard to display a test result based on the user information lookup.
